(19) United States
(12) Patent Application Publication
(10) Pub. No.: US 2020/0091720 A1
(43) Pub. Date: Mar. 19, 2020

(54) CONTROL METHOD OF A GENERATOR

(71) Applicant: Schneider Electric Industries SAS, Rueil Malmaison (FR)

(72) Inventors: Audrey MOULICHON, Grenoble (FR); Mazen ALAMIR, Saint Martin D'Heres (FR); Mustapha Amine RAHMANI, Saint Martin D'Heres (FR); Lauric GARBUIO, Saint Martin le Vinoux (FR); Vincent DEBUSSCHERE, Grenoble (FR); Miao-Xin WANG, Montbonnot Saint Martin (FR); Nouredine HADJ-SAID, Grenoble (FR)

(73) Assignee: Schneider Electric Industries SAS, Rueil Malmaison (FR)

(21) Appl. No.: 16/522,118

(22) Filed: Jul. 25, 2019

(30) Foreign Application Priority Data
Sep. 18, 2018 (FR) 18 58434

(51) Int. Cl. H02J 3/18; H02J 3/38; H02M 1/42; H02M 7/537

(52) U.S. Cl. CPC H02J 3/18; H02M 7/537; H02M 1/42; H02J 3/382

(57) ABSTRACT

A method of controlling a generator including an inverter with electronic switches which, controlled on the basis of instantaneous cyclic ratios α_{abc}, enable the inverter to deliver to an electrical distribution grid an electrical power P_{abc} at an AC voltage V_{abc}, termed the source voltage, and an AC current I_{abc}, termed the source current, the voltage V_{abc} and current I_{abc} having a frequency f_{abc}, the inverter being controlled by a control law that includes: a) an integration loop to evaluate a difference ε between the current I_{abc} and a grid current Iᵣ actually required by the electrical distribution grid; b) a correction loop which, as soon as the difference ε is greater than a difference ε* termed the reference difference, controls the adjustment by the source current inverter of the instantaneous cyclic ratios α_{abc} so as to reduce the difference ε to a value less than the reference difference ε*.

### TECHNICAL FIELD

The present invention concerns a method of controlling a generator, and more particularly a generator including an inverter.

The present invention concerns in particular a method of controlling a generator intended to ensure stable operation of the latter.

### Prior Art

The virtual generator concept, highlighted in particular by the introduction of microgrids, is known in the prior art and described in the document [1] cited at the end of the description.

A generator of this kind in particular includes a source of electrical power, such as photovoltaic panels, and an inverter. The source of electrical power generates a DC voltage and a DC current intended to be converted by the inverter into an AC voltage and an AC current before being injected into the electrical distribution grid.

This virtual generator has a control law enabling said generator to reduce (smooth) the effect of electrical power fluctuations of the power source on the electrical distribution grid.

Under some conditions a virtual generator of this kind may nevertheless exhibit instabilities, in particular in the event of a short circuit and in the event of a low current circulating in the microgrid.

In order to alleviate this problem, impedances, termed virtual impedances, have been considered in the control law in order to guarantee the stability of the model governing it. To this end, the person skilled in the art may consult the document [2] cited at the end of the description.

However, the configuration of such impedances can be complicated, and is above all dependent on the architecture of the microgrid in which the virtual generator is installed.

Moreover, the use of virtual impedances imposes sampling the current, in particular a reference current, at the output of the inverter commensurately affecting the efficiency of the virtual generator.

An object of the present invention is therefore to propose a method of controlling a generator enabling stable operation of the latter to be assured.

Another object of the present invention is to propose a method of controlling a generator that is little or not at all dependent on the generator concerned.

Another object of the present invention is to propose a method of controlling a generator enabling stable operation of the latter to be assured that is simpler to implement than the known prior art methods.

### SUMMARY OF THE INVENTION

The objects of the invention are at least in part achieved by a method of controlling a generator including an inverter provided with electronic switches which, controlled on the basis of instantaneous cyclic ratios α_{abc}, enable said inverter to deliver to an electrical distribution grid an electrical power P_{abc} at an AC voltage V_{abc}, termed the source voltage, and an AC current I_{abc}, termed the source current, said voltage V_{abc} and current I_{abc} having a frequency f_{abc}, the inverter being controlled by a control law that includes:

a) an integration loop intended to evaluate a difference ε between the source current I_{abc} and a current Iᵣ, termed the grid current, estimated by an observation loop and actually required by the electrical distribution grid;

b) a correction loop which, as soon as the difference ε is greater than a difference ε* termed the reference difference, controls the adjustment by the inverter of the instantaneous cyclic ratios α_{abc} in such a manner as to reduce the difference ε to a value less than the reference difference ε*.

According to one embodiment, the grid current Iᵣ is estimated on the basis of the source voltage V_{abc}, the source current I_{abc} and the frequency f_{abc}.

According to one embodiment, the step a) includes measurement of the source voltage V_{abc}, the source current I_{abc}, and the frequency f_{abc}, and the source voltage V_{abc}, the source current I_{abc}, and the frequency f_{abc} are advantageously measured at the level of terminals connecting the inverter to the electrical distribution grid.

According to one embodiment, the observation loop also estimates on the basis of the source voltage V_{abc}, the source current I_{abc} and the frequency f_{abc}a voltage Vᵣ, termed the grid voltage, actually required on the electrical distribution grid, the grid voltage Vᵣ and the grid current Iᵣ being estimated on the basis of a model of the connection of the inverter to the electrical distribution grid.

According to one embodiment, the correction loop determines, on the basis of the grid voltage Vᵣ and the difference Δε between the difference ε and the reference difference ε*, a current and a voltage respectively termed the adjusted current I_{abcref} and the adjusted voltage V_{abcref} that the inverter must actually deliver to the electrical distribution grid.

According to one embodiment, the correction loop estimates a first adjustment difference εₓ between the adjusted current I_{abcref} and the source current I_{abc} and between the adjusted voltage V_{abcref} and grid voltage Vᵣ.

It is understood that the first adjustment difference includes at least two components respectively relating to the difference between the adjusted current I_{abcref} and the source current I_{abc} and the difference between the adjusted voltage V_{abcref} and the grid voltage Vᵣ.

According to one embodiment, the correction loop estimates a second adjustment difference εᵤ between the adjusted ratios α_{ref} and the instantaneous cyclic ratios α_{abc}, the adjusted ratios α_{ref} being the cyclic ratios enabling the inverter to deliver the adjusted current I_{abcref} and the adjusted voltage V_{abcref}

According to one embodiment, the correction loop estimates, on the basis of the first adjustment difference εₓ and the second adjustment difference εᵤ, the correction Δα_{ref} to be made to the instantaneous cyclic ratios α_{abc} for the inverter to deliver the adjusted current I_{abcref}.

According to one embodiment, the difference ε is evaluated in successive time increments in such a manner as to determine the evolution thereof.

According to one embodiment, the dynamic of adjustment by the inverter of the source current I_{abc} depends on the evolution of the difference ε.

According to one embodiment, the inverter forms with at least one source of energy, advantageously of renewable energy, an accumulation system including a reserve of power and/or of energy, and the control law, a virtual generator, the electrical power P_{abc} being an active and/or reactive power controlling by statism, respectively, the frequency f and the RMS voltage Vᵣₘₛ of the source voltage V_{abc}, the method including control of the virtual generator by the control law so that it executes an adjustment of the power P_{abc} delivered to the electrical distribution grid, said adjustment being adapted to compensate a variation of the active/reactive power consumed by the grid.

According to one embodiment, the control law is adapted to confer on the virtual generator, advantageously via the inverter, the possibility of forming the grid.

According to one embodiment, the control law is adapted to connect the virtual generator in parallel with at least one other power source connected to the distribution grid.

According to one embodiment, the accumulation system applies a DC voltage V_{ref} to first terminals of the energy source so that the energy source delivers a power Pₛᵣ, said power Pₛᵣ is liable to feature power fluctuations, the accumulation system is controlled to compensate the fluctuations.

The invention also concerns a computer program including instructions which, when the program is executed by a computer or a control card, lead to execution of the method according to the present invention.

The invention also concerns a generator including an inverter provided with electronic switches which, controlled on the basis of instantaneous cyclic ratios α_{abc}, enable said inverter to deliver to an electrical distribution grid an electrical power P_{abc} at an AC voltage V_{abc}, termed the source voltage, and an AC current I_{abc}, termed the source current, said voltage V_{abc} and current I_{abc} having a frequency f_{abc}, the inverter being controlled by a control law that includes:

a) an integration loop intended to evaluate a difference ε between the source current I_{abc} and a current Iᵣ, termed the grid current, estimated by an observation loop and actually required by the electrical distribution grid;

b) a correction loop which, as soon as the difference ε is greater than a difference ε* termed the reference difference, controls the adjustment by the inverter of the source current I_{abc} in such a manner as to reduce the difference ε to a value less than the reference difference ε*.

### BRIEF DESCRIPTION OF THE DRAWINGS

Other features and advantages will become apparent in the following description of embodiments of the method according to the invention of controlling a generator, given by way of nonlimiting example with reference to the appended drawings, in which:

FIG. 1 is a diagrammatic representation of a known prior art virtual generator described in the document [1] cited at the end of the description, the generator shown including a source of renewable energy;

FIG. 2 is a diagrammatic representation of the method according to the present invention;

FIG. 3 is a representation of the frequency f of the current and of the voltage as a function of the active power P delivered by an electrical generator set, the frequency f being represented on the vertical axis and the active power P on the horizontal axis;

FIG. 4 is a representation of the RMS voltage Vᵣₘₛ of the voltage V as a function of the reactive power Q delivered by the electrical generator set, the RMS voltage Vᵣₘₛ being represented on the vertical axis and the reactive power Q on the horizontal axis;

FIG. 5 is a representation of an equivalent electrical circuit diagram of the connection of the inverter to the electrical distribution grid.

### DETAILED DESCRIPTION OF PARTICULAR EMBODIMENTS

The present invention described in detail hereinafter employs a method of controlling a generator including an inverter delivering to an electrical distribution grid an electrical power P_{abc}.

In particular, the generator employs a control law enabling adjustment of the current delivered to the distribution grid so that there is an equilibrium between the power consumed and the power supplied.

The invention will now be described in the context of a virtual generator, and in particular in the context of the virtual generator described in the document [1]. In this regard, the content of the document [1] is hereby incorporated by reference.

The invention, although described in the context of the virtual generator, must not be limited to that aspect, however. In particular, any generator generally including an inverter 4 intended to inject an AC current and an AC voltage into a grid could be considered.

By virtual generator is meant a generator behaving like an electrical generator set.

A virtual generator 1 according to the present invention includes an inverter 4 that delivers to an electrical distribution grid an active/reactive power P_{abc}.

The active power P_{abc} and the reactive power Q_{abc} are characterized by an AC voltage V_{abc}, termed the source voltage, and an AC current I_{abc}, termed the source current, both at a frequency f_{abc}.

The source voltage V_{abc} and the source current I_{abc} are respectively the result of conversion by the inverter 4 of a DC voltage V_{c} and a DC current I_{c} produced by an energy source 2.

The energy source 2 may be a source of renewable energy, and for example employ photovoltaic panels, wind power, water power, thermodynamic machines.

The inverter 4 includes electronic switches which, controlled on the basis of cyclic ratios termed instantaneous cyclic ratios α_{abc}, impose said inverter 4 delivering the source current I_{abc} of frequency f_{abc}.

The electronic switches may for example comprise insulated gate bipolar transistors (IGBT).

The virtual generator 1 may also include a power and/or energy accumulation system 3.

The virtual generator 1 according to the invention is controlled by a control law that incorporates differential equations enabling modelling of the functioning (behaviour) of the electrical generator set. Thus the virtual generator 1 is configured to emulate the behaviour of a synchronous generator, and more particularly that of an electrical generator set. Configuring the virtual generator 1 then includes determining the differential equations governing the operation of the synchronous generator and developing a computer program (or algorithm) based on said differential equations. This is a configuration technique known to the person skilled in the art and is described in the document [1].

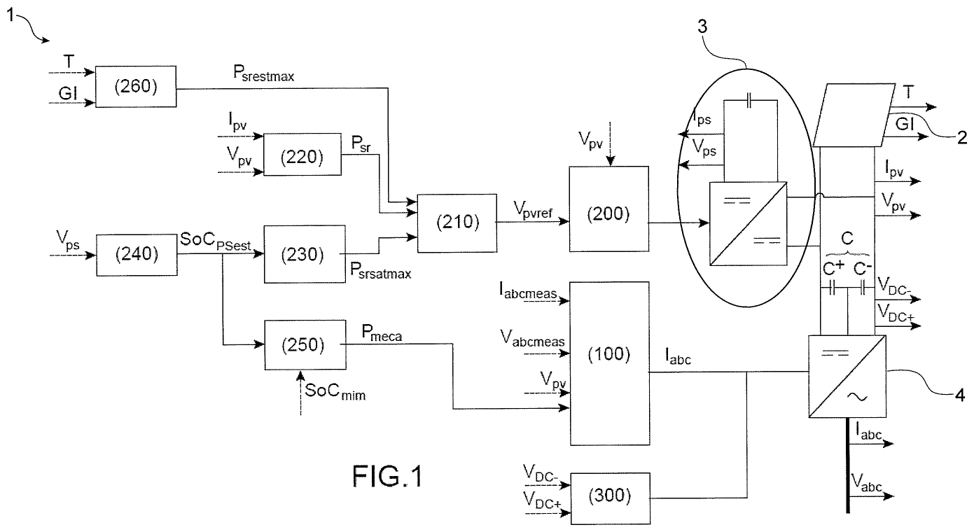

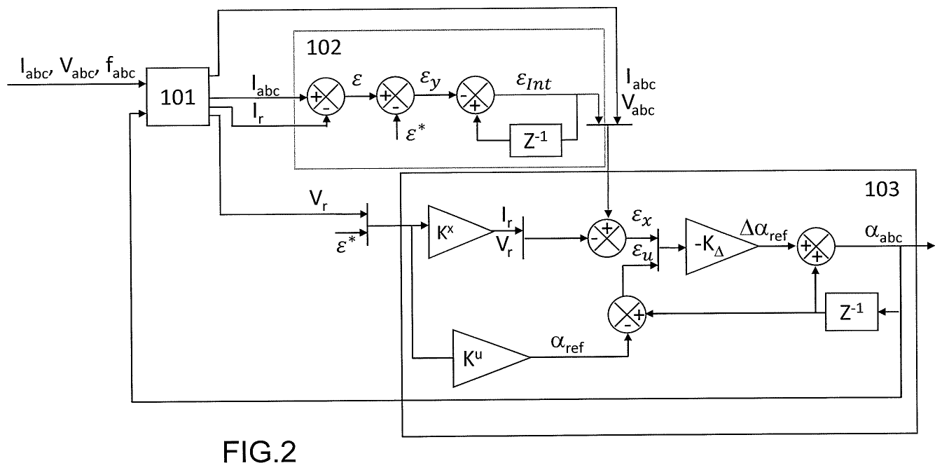

In this regard, and referring to FIG. 1 (FIG. 1a of the document [1]), the control law may include various control blocks. The latter includes in particular a block 100 denoted “virtual generator”.

It is understood that the control law is executed by information technology means such as a computer, a processor, or again a control card provided for example with a processor.

Via the block 100, the control law imposes delivery by the inverter 4 of the source current I_{abc}. The reference value of the current I_{abc} may be determined by the block 100 as a function of the voltage V_{abc} delivered by the inverter 4 and measured at its output (V_{abcmes}). The inverter 4 therefore produces the current I_{abc} from an electrical generator set delivering a voltage V_{abc} and satisfying the differential equations modelling said electrical generator set.

The control law of the inverter 4 is also adapted, using techniques known to the person skilled in the art, to confirm on the virtual generator 1 the possibility of forming the grid (a process known as “grid forming”).

The virtual generator 1 can therefore on its own supply electrical power to the microgrid just as an electrical generator set would.

The control law is also adapted to enable the virtual generator 1 to respond to load calls from the electrical distribution grid.

A load call includes either connection or disconnection of a load or a variation of the power consumed by said load on the electrical distribution grid.

The control law, and more particularly the block 100, may employ an observation loop 101, an integration loop 102 and a correction loop 103.

The observation loop 101 is intended to determine a current Iᵣ, termed the grid current, actually required by the electrical distribution grid.

The grid current Iᵣ may be estimated on the basis of the source voltage V_{abc} and the source frequency f_{abc}.

In fact, as soon as a load is connected to or disconnected from the electrical distribution grid a load call makes itself felt directly at the level of the connection between the inverter 4 and the electrical distribution grid and is reflected in a variation up or down of the source current I_{abc} and the source voltage V_{abc}.

These variations, and in particular the variation of the source voltage V_{abc}, make it possible to determine the grid current Iᵣ by modelling the connection between the inverter 4 and the electrical distribution grid.

According to the same principle, the observation loop 101 also estimates on the basis of the source voltage V_{abc}, the source current I_{abc} and the frequency f_{abc} the voltage Vᵣ, termed the grid voltage, actually required on the electrical distribution grid.

This modelling, which relies on the characteristics of the electrical distribution grid and on the inverter 4, is well known to the person skilled in the art and is therefore not described in detail in the present application.

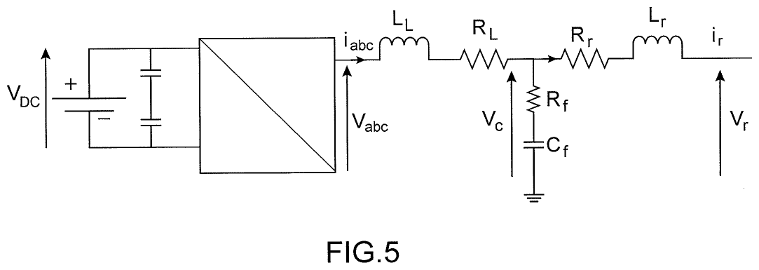

This modelling in particular establishes equations for the connection of the inverter 4 to the electrical distribution grid. In this regard, FIG. 5 shows the equivalent electrical circuit diagram of the connection between the inverter 4 and the electrical distribution grid. The symbols appearing in FIG. 5 are defined in the following table:

| Notation | |
|---|---|
| V_{DC} | DC voltage of the inverter |
| V_{abc}, V_{abc}^{d} and | Respectively, single-wire voltage of the inverter, |
| V_{abc}^{q} | and voltage of the inverter on the axis dq and per |
| | unit, with |
| | ${V}_{i} = α \frac{{V}_{DC}}{2}$ |
| a_{d} and a_{q} | Cyclic ratios of the inverter, respectively on the |
| | axis dq and per unit |
| V_{c}, e^{d} and e^{q} | Respectively, single-wire filtered voltage, voltage |
| | filter on the axis dq, and per unit |
| Vᵣ, Vᵣ^{d} and Vᵣ^{q} | Respectively, single-wire grid voltage, and grid |
| | voltage on the axis dq and per unit |
| i_{abc}, i_{abc}^{d} and i_{abc}^{q} | Respectively, single-wire inverter current, and |
| | inverter current on the axis dq and per unit |
| iᵣ, iᵣ^{d} and iᵣ^{q} | Respectively, single-wire grid current, and grid |
| | current on the axis dq and per unit |
| L_{L} and R_{L} | Respectively, impedance and resistance of the |
| | inverter |
| Lᵣ and Rᵣ | Respectively, impedance and resistance of the grid |
| C_{f} and R_{f} | Respectively, capacitance and resistance of the filter |

The observation loop is therefore able to measure the source current I_{abc}, the source voltage V_{abc} and the frequency f_{abc} in order to detect a load call. In particular, the source voltage V_{abc}, the source current I_{abc} and the frequency f_{abc} are measured at the level of terminals connecting the inverter 4 to the electrical distribution grid.

The measurement may be executed at regular time intervals, for example at a frequency of 6.66 kHz.

The integration loop 102 evaluates a difference ε between the source current I_{abc} and the grid current Iᵣ estimated by the observation loop.

This difference ε can then be compared to a difference ε* termed the reference difference. The result of this comparison is a difference termed the integration difference denoted εᵢₙₜ.

The reference difference ε* may be, for example, less than 10%, preferably less than 5%. In a particularly advantageous manner, the reference difference ε* is zero.

The integration difference εᵢₙₜ may be evaluated at regular time intervals, for example at a frequency of 20 kHz.

The integration loop 102 is also able to evaluate the evolution of the integration difference εᵢₙₜ. In particular, the integration loop 102 is able to evaluate the difference εᵢₙₜ between two successive integration differences εᵢₙₜ.

The correction loop 103 is adapted to control adjustment by the inverter 4 of the source current I_{abc}. In particular, as soon as the difference ε is greater than the reference difference ε*, the correction loop 103 calculates the cyclic ratios α_{ref} enabling the inverter 4 to reduce the difference ε to a value less than the reference difference ε*.

In particular, on the basis of the grid voltage Vᵣ and the difference between the difference ε and the reference difference ε* the correction loop 103 determines a current I_{abcref} and a voltage V_{abcref} respectively termed the adjusted current and the adjusted voltage that the inverter 4 must actually deliver to the electrical distribution grid.

Determination of the adjusted current I_{abcref} and of the voltage V_{abcref} is then followed by estimation by the correction loop 103 of a difference εₓ, termed the first adjustment, between said adjusted current I_{abcref} and the source current I_{abc} and between the adjusted voltage V_{abcref} and the source voltage Vabc.

The correction loop is also able to evaluate a difference εᵤ termed the second reference difference of the adjusted cyclic ratios α_{ref} and the instantaneous cyclic ratios α_{abc} associated with the current I_{abc} actually delivered by the inverter 4.

On the basis of the first adjustment εₓ and the second adjustment εᵤ, the correction loop determines the correction Δα_{ref} to be made to the cyclic ratios for the inverter 4 to deliver to the electrical distribution grid the adjusted current I_{abcref}. In a particularly advantageous manner, the correction loop 103 includes a linear quadratic regulator.

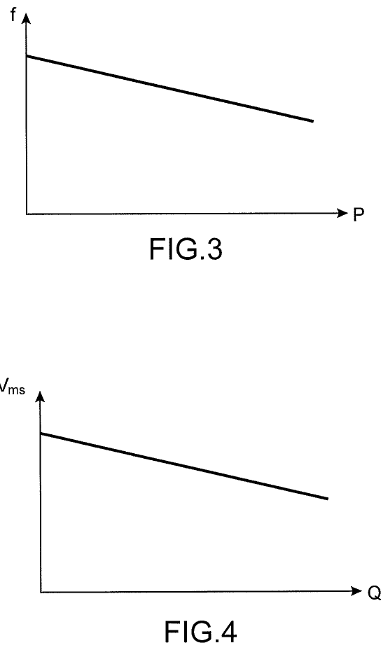

In a particularly advantageous manner, the virtual generator 1 uses control by statism at frequency f_{abc}/active power P_{abc}. Control by statism at frequency f_{abc}/active power P_{abc} is a characteristic of a synchronous generator, such as an electrical generator set. An electrical generator set generally includes a shaft driven in rotation by a diesel engine at a frequency that corresponds to the frequency f of the current and of the voltage produced by said set. The shaft frequency follows control by statism at frequency f/active power P in accordance with a law shown in FIG. 3. The control by statism at frequency f/active power P enables the electrical generator set to adapt the frequency f of the signal that it delivers as a function of the active electrical power P that it supplies. This statism effect enables parallel connection of different electrical generator sets that will deliver to the grid a current and a voltage at the same frequency f. In the context of the virtual generator 1 according to the invention, the frequency f of the current and of the voltage delivered by said virtual generator 1 depend on the specifications of the microgrid (known as the grid code). For example, the frequency f may be between 48 and 52 Hz inclusive, or again between 49.5 and 50.5 Hz, or between 58 and 62 Hz, or between 59.5 and 60.5 Hz.

Also in a particularly advantageous manner, the virtual generator 1 also employs control by statism at RMS voltage Vᵣₘₛ/reactive power Q (Vᵣₘₛ being the RMS voltage of the source voltage V_{abs}). Control by statism at RMS voltage Vᵣₘₛ/reactive power Q is a characteristic of a synchronous generator such as an electrical generator set. An electrical generator set generally includes a rotor driven in rotation inside a stator and an automatic voltage regulator (AVR) operating on the rotor windings of the rotor. The automatic voltage regulator therefore applies to the rotor a voltage as a function of a voltage of the electrical signal (and therefore the power) delivered by the stator (by the electrical generator set) to the grid. The RMS voltage Vᵣₘₛ of the electrical signal delivered by the electrical generator set follows control by statism at RMS voltage Vᵣₘₛ/reactive power Q in accordance with a law shown in FIG. 4. Control by statism at RMS voltage Vᵣₘₛ/reactive power Q enables the electrical generator set to adapt the RMS voltage Vᵣₘₛ of the voltage that it delivers as a function of the reactive electrical power Q that it supplies.

The method of controlling the inverter as described hereinabove is independent of the configuration of the grid or of the installation concerned and has a simpler configuration relative to the known prior art control methods.

### REFERENCES

[1] EP3208907;
[2] Rahmani et al., “Virtual Synchronous Generators for microgrid stabilization: Modeling, implementation and experimental validation on a microgrid laboratory”, IEEE 2017 Asian Conference on Energy, Power and Transportation Electrification.

1. A method of controlling a generator comprising an inverter provided with electronic switches which, controlled on the basis of instantaneous cyclic ratios α_{abc}, enable said inverter to deliver to an electrical distribution grid an electrical power P_{abc} at an AC voltage V_{abc}, termed the source voltage, and an AC current I_{abc}, termed the source current, said voltage V_{abc} and current I_{abc} having a frequency f_{abc}, the inverter being controlled by a control law that comprises:
a) an integration loop configured to evaluate a difference ε between the source current I_{abc} and a current Iᵣ, termed the grid current, estimated by an observation loop and actually required by the electrical distribution grid;
b) a correction loop which, as soon as the difference ε is greater than a difference ε*, termed the reference difference, controls the adjustment by the inverter of the instantaneous cyclic ratios α_{abc} in such a manner as to reduce the difference ε to a value less than the reference difference ε*.

2. The method according to claim 1, wherein the grid current Iᵣ is estimated on the basis of the source voltage V_{abc}, the source current I_{abc} and the frequency f_{abc}.

3. The method according to claim 1, wherein the step a) includes measurement of the source voltage V_{abc}, the source current I_{abc}, and the frequency f_{abc}, and the source voltage V_{abc}, the source current I_{abc}, and the frequency f_{abc} are measured at the level of terminals connecting the inverter to the electrical distribution grid.

4. The method according to claim 1, wherein the observation loop also estimates based on the source voltage V_{abc}, the source current I_{abc} and the frequency f_{abc}, a voltage Vᵣ, termed the grid voltage, actually required on the electrical distribution grid, the grid voltage Vᵣ and the grid current Iᵣ being estimated on the basis of a model of the connection of the inverter to the electrical grid.

5. The method according to claim 4, wherein the correction loop determines, on the basis of the grid voltage Vᵣ and the difference Δε between the difference s and the reference difference ε*, a current and a voltage respectively termed adjusted current I_{abcref} and the adjusted voltage V_{abcref} that the inverter must actually deliver to the electrical distribution grid.

6. The method according to claim 5, wherein the correction loop estimates a first adjustment difference εₓ between the adjusted current I_{abcref} and the source current I_{abc} and between the adjusted voltage V_{abcref} and the source voltage V_{abc}.

7. The method according to claim 5, wherein the correction loop estimates a second adjustment difference εᵤ between the adjusted ratios α_{ref} and the instantaneous cyclic ratios α_{abc}, the adjusted ratios α_{ref} being the cyclic ratios enabling the inverter to deliver the adjusted current I_{abcref} and the adjusted voltage V_{abcref}.

8. The method according to claim 6, wherein the correction loop estimates, on the basis of the first adjustment difference εₓ and the second adjustment difference εᵤ, the correction Δα_{ref} to be made to the instantaneous cyclic ratios α_{abc} for the inverter to deliver the adjusted current I_{abcref}.

9. The method according to claim 1, wherein the difference ε is evaluated in successive time increments in such a manner as to determine the evolution thereof.

10. The method according to claim 9, wherein the dynamic of adjustment by the inverter of the source current I_{abc} depends on the evolution of the difference ε.

11. The method according to any one of the preceding claim 1, wherein the inverter forms with at least one source of renewable energy, an accumulation system including a reserve of power and/or of energy, and the control law, a virtual generator, the electrical power P_{abc} being an active and/or reactive power controlling by statism, respectively, the frequency f and the RMS voltage Vᵣₘₛ of the source voltage V_{abc}, the method comprising control of the virtual generator by the control law so that it the virtual generator executes an adjustment of the power P_{abc} delivered to the electrical distribution grid, said adjustment being adapted to compensate a variation of the active/reactive power consumed by the grid.

12. The method according to claim 11, wherein the control law is adapted to confer on the virtual generator, via the inverter, the possibility of forming the grid.

13. The method according to claim 11, wherein the control law is adapted to connect the virtual generator in parallel with at least one other power production source connected to the distribution grid.

14. The method according to claim 11, wherein the accumulation system applies a DC voltage V_{ref} to first terminals of the energy source so that the energy source delivers a power Pₛᵣ, said power Pₛᵣ is liable to feature power fluctuations, the accumulation system is controlled to compensate the fluctuations.

15. A computer program comprising instructions which, when the program is executed by a computer or a controlled card, lead to execution of the method according to claim 1.

16. A generator comprising an inverter provided with electronic switches which, controlled on the basis of instantaneous cyclic ratios α_{abc}, enable said inverter to deliver to an electrical distribution grid an electrical power P_{abc} at an AC voltage V_{abc}, termed the source voltage, and an AC current I_{abc}, termed the source current, said voltage V_{abc} and current I_{abc} having a frequency f_{abc}, the inverter being controlled by a control law that includes:
a) an integration loop intended to evaluate a difference α between the source current I_{abc} and a current Iᵣ, termed the grid current, estimated by an observation loop and actually required by the electrical distribution grid;
b) a correction loop which, as soon as the difference ε is greater than a difference ε* termed the reference difference, controls the adjustment by the inverter of the instantaneous cyclic ratios α_{abc} in such a manner as to reduce the difference ε to a value less than the reference difference ε*.
